(19) United States
(12) Patent Application Publication
(10) Pub. No.: US 2004/0195891 A1
(43) Pub. Date: Oct. 7, 2004

(54) Ground lounger

(76) Inventor: Clifford Eugene Vaughan, Powell, TN (US)

Correspondence Address: Mr. Clifford E. Vaughan, 7608 LaBarrington Blvd., Powell, TN, 37849, US

(21) Appl. No.: 10/384,903

(22) Filed: Mar. 11, 2003

(51) Int. Cl. B60N 2/02

(52) U.S. Cl. 297/377

(57) ABSTRACT

The Ground Lounger is a seat that can be adjusted to fit the individual's preference for comfortable seating on the ground or floor. The ground does not have to be near level to achieve comfortable seating. The seat cushion is comprised of closed cell foam that will not transmit water, thereby keeping the user dry and warm, even on wet ground. The new features of the Ground Lounger as compared to any other invention is the manner in which the frame is assembled to be fully adjustable to ground slope and foldable for transport. The Ground Lounger is comprised of aluminum tubing and fabric that can be adjusted with straps to account for the natural slope of the ground to provide the user with the desired angle of backrest. The front and rear legs of the Ground Lounger form an A-frame that is held in position with an adjustable strap. The adjustability of the A-frame is the central feature that allows for using the Ground Lounger on sloping or flat ground. The entire Ground Lounger is easily folded to a rectangular shape less than 2-inches in thickness, weighing less than 2 pounds. Since the entire Ground Lounger is comprised of lightweight aluminum and fabric, it is extremely easy to transport to wherever it is needed. Previous problems with available seats were that they have been made to operate as a chair and require relatively level ground for use. They are also somewhat bulky and not as easily transported. Individuals could not adjust the angle of the backrest for their comfort and to compensate for the natural ground slope.

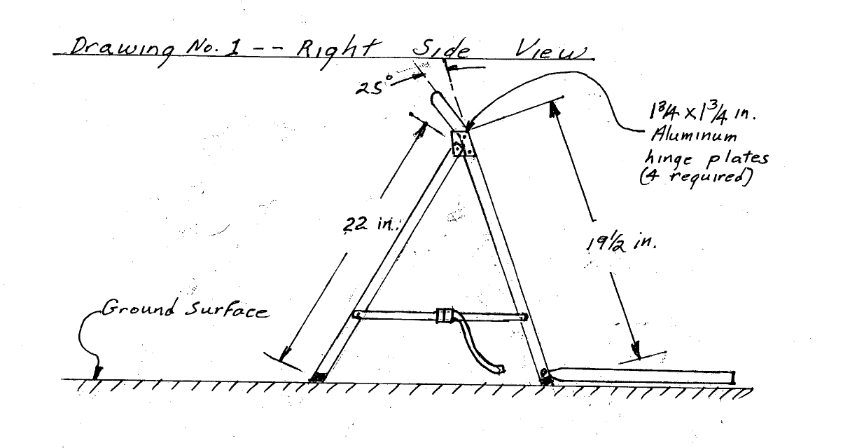

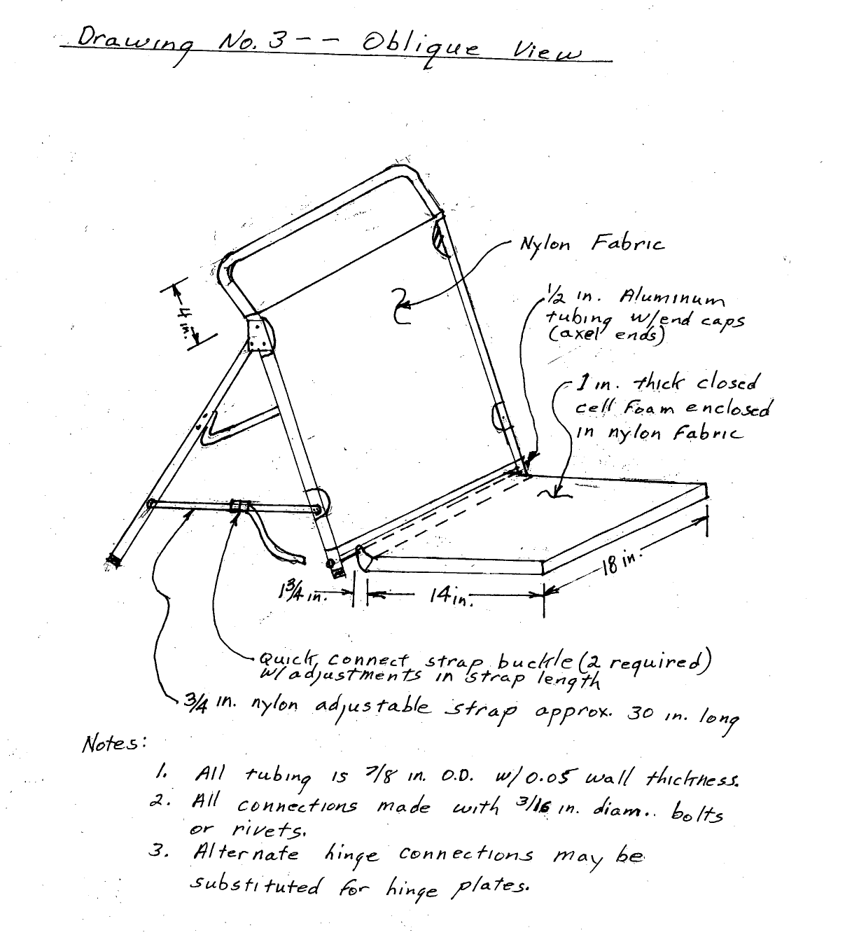

### CROSS-REFERENCE TO RELATED APPLICATIONS

Not Applicable

### STATEMENT REGARDING FEDERALLY SPONSORED RESEARCH OR DEVELOPMENT

There was no federally sponsored research or development money used in the development of this invention.

### REFERENCE TO SEQUENCE LISTING, A TABLE, OR COMPUTER PROGRAM LISTING COMPACT DISK APPENDIX

Not Applicable

### BACKGROUND OF THE INVENTION

This invention applies to seating in the field of sports and outdoor recreation. It is used to improve the comfort of people engaged in camping, hunting, hiking, fishing, picnicking, watching sporting events, attending outdoor meetings, conferences, rallies, and musical shows. It can be used at lakes, swimming pools, and beaches. The angle of the backrest is completely adjustable, allowing the Ground Lounger to be used on sloping or flat ground.

I am not aware of any other inventions related to this invention. Other ground type seats with which I am familiar do not have a sturdy backrest which can be adjusted for individual preferences and cannot be used comfortably on uneven ground.

### BRIEF SUMMARY OF THE INVENTION

This invention is a ground seat that can be adjusted to fit the individual's preference for comfortable seating on the ground. The backrest is comprised of aluminum tubing and fabric that can be adjusted to account for the natural slope of the ground to provide the user with the desired angle of backrest. The seat cushion is comprised of closed cell foam that will not transmit water, thereby keeping the user dry, even on wet ground. The entire Ground Lounger is easily folded to a rectangular shape less than 2-inches in thickness, weighing less than 2 pounds. Since the Ground Lounger is comprised of lightweight aluminum and fabric, and collapses to a flat shape it is extremely easy to transport to wherever it is needed.

The frame of the Ground Lounger is made from aluminum tubing where the front legs and rear legs hinge at the top to form an A-frame that is used as the backrest for the seat. An adjustable nylon strap with a quick connect/disconnect is attached between the front and rear legs of the A-frame and used to hold the position of the legs. The rear legs being longer than the front legs, and the width of the A-frame being adjustable with the strap, allows the backrest to be adjusted to achieve a comfortable angle irrespective of the ground slope. The seat folds down to lay flat on the ground forming a solid seat for the user. The seat portion is made from closed cell foam for comfort and to be waterproof.

Previous problems with seats available were that they have been made to resemble a chair and require relatively level ground to use. They are also somewhat bulky and not as easily transported. Individuals could not adjust the angle of the backrest to compensate for the natural ground slope.

### BRIEF DESCRIPTION OF THE SEVERAL VIEWS OF THE DRAWING

Drawing Number 1

A side view of the Ground Lounger with construction dimensions shown.

Drawing Number 2

A rear view of the Ground Lounger with construction dimensions shown.

Drawing Number 3

An oblique view of the Ground Lounger with construction dimensions and construction notes shown.

### BRIEF DESCRIPTION OF THE PHOTOGRAPHS

Photograph 1

A view of the Ground Lounger set up and ready for use on level ground.

Photograph 2

A side view of the Ground Lounger set up and being used on level ground. Note the positioning of the rear support legs and adjustable strap for support.

Photograph 3

Rear oblique view of the Ground Lounger set up and being used on level ground.

Photograph 4

Side oblique view of the Ground Lounger set up and being used on steeply sloping ground.

Photograph 5

Side view of the Ground Lounger folded and ready for transport. Note the compact profile that is slightly more than 2-inches thick and flat so it is easily carried with a carrying strap or in a case.

### DETAILED DESCRIPTION OF THE INVENTION

The Ground Lounger is a seat for sitting comfortably on the ground that can be adjusted to fit the individual's preference for comfortable seating. There are many occasions when people prefer or need to sit on the ground and would like to be in comfort. Sifting on the ground does not usually allow a backrest nor can the slope of the ground be compensated. When using the Ground Lounger the ground does not have to be nearly level to achieve comfortable seating. Also, the seat bottom is comprised of closed cell foam that will not transmit water, thereby keeping the user dry and warm, even on wet ground. The new features of the Ground Lounger as compared to any other invention is the manner in which the frame is assembled to be fully adjustable to ground slope and foldable to a flat package for transport. The backrest is comprised of aluminum tubing and fabric that can be adjusted with straps to account for the natural slope of the ground to provide the user with the desired steepness of backrest. The entire Ground Lounger is easily folded to a rectangular shape less than 2-inches in thickness, weighing less than 2 pounds. Since the Ground Lounger is comprised of lightweight aluminum and fabric, it is extremely easy to transport to wherever it is needed. Previous problems with available seats were that they have been made to operate as a chair and require relatively level ground to use They are also somewhat bulky and not as easily transported. Individuals could not adjust the steepness of the backrest for their comfort and to account for the natural ground slope.

The Ground Lounger is constructed with ⅞-inch aluminum tubing, rivets or bolts, 1-inch thick closed cell foam, and nylon fabric, all components that are readily available. The tubing is bent to the specifications shown on the drawings, holes drilled for rivets or bolts, and fabric sewn to fit tightly on the frame when assembled, and the Ground Lounger is assembled. The hinge plates may be constructed as shown or an alternate hinge mechanism may be substituted. The adjustment strap is added as the final step in assembly and is critical for seat adjustment and safety. The Ground Lounger is set up by first unsnapping the quick disconnect on the adjustment strap, then set the Ground Lounger in position as desired with the front and rear legs forming an A-frame, and reconnect the adjustment strap.

The adjustable nylon strap with a quick connect/disconnect is attached between the front and rear legs of the A-frame and used to hold the position of the legs. The rear legs being longer than the front legs, and the width of the A-frame being adjustable with the strap, allows the backrest to be adjusted to achieve a comfortable angle for the backrest irrespective of the ground slope. The seat cushion folds down flat on the ground forming a comfortable seat for the user. The seat cushion is made from closed cell foam for comfort and to be waterproof. On steeply sloping ground it may be necessary to place an object such as a piece of firewood or rolled towel under the front edge of the seat cushion to provide leveling for the cushion.

What I claim as my invention is a ground seat that can be adjusted to fit the ground conditions and the individual's preference for comfortable seating on the ground with the following specific advantages:

1. The Ground Lounger is comprised of aluminum tubing and fabric that form a backrest and seat which can be adjusted with straps to compensate for the natural slope of the ground to provide the user with the desired angle of backrest to meet individual preferences.

2. The Ground Lounger folds to a flat, light weight package that is easily transported or stored.

3. The Ground Lounger bottom is comprised of closed cell foam that will not transmit water, thereby keeping the user dry, and warm, even on wet ground.

4. The Ground Lounger provides unique seating for hunters, fishermen, sports fans, picnickers, family gatherings, hikers, campers, clubs, meetings, and any other group or individual that has a need to for sitting on the ground or floor in comfort.

5. The Ground Lounger can also be used indoors in the same ways that it is used outdoors.

6. The rear legs being longer than the front legs, and the width of the A frame being adjustable with the strap, allows the backrest to be adjusted to achieve a comfortable angle for the backrest even on sloping ground.

7. A simple rolled towel or piece of firewood placed under the front edge of the seat cushion can allow the Ground Lounger to be used on steeply sloping ground in comfort. The rear legs can be adequately adjusted on steep ground to control the steepness of the backrest.
